(19) United States
(12) Patent Application Publication
(10) Pub. No.: US 2026/0005575 A1
(43) Pub. Date: Jan. 1, 2026

(54) OVERMOLDED FLOW INSERT FOR A ROTOR SHAFT

(71) Applicant: DANA TM4 INC., Boucherville (CA)

(72) Inventors: Sandesh Rathnavarma HEGDE, Laval (CA); Alexandre PARE, Saint-Amable (CA); Donald W. DINE, Whitehouse, OH (US); Sabahattin DIZDAR, Montreal (CA); Simon DESROCHERS, Boucherville (CA); Salvatore STAMATO, Boucherville (CA)

(21) Appl. No.: 18/756,574

(22) Filed: Jun. 27, 2024

(51) Int. Cl. H02K 7/00; H02K 1/02; H02K 1/32

(52) U.S. Cl. CPC H02K 7/003; H02K 1/02; H02K 1/32

(57) ABSTRACT

Systems are provided for a rotor shaft assembly for an electric machine. A rotor shaft assembly includes a shaft, a shaft end cap, and a flow insert arranged in a cavity shaped by the shaft and the shaft end cap. The flow insert comprises an inner core formed of a first material; and an outer shell formed of a second material different from the first material, where the outer shell is overmolded over the inner core, and where the outer shell comprises flow channels.

### TECHNICAL FIELD

The present description relates generally to a rotor assembly of an electric machine.

### BACKGROUND AND SUMMARY

Electric machines, such as electric motors, are used in vehicle powertrains and other systems to provide mechanical power to desired components. For example, an electric machine of a vehicle transfers torque to a gearbox of the vehicle, where the gearbox provides rotational power to wheels of the vehicle. Like an engine, the electric motor may demand cooling during certain operating conditions to control a temperature of components of the electric motor.

To increase electric motor efficiency and continuous performance in vehicle drive units and other systems, motors may use cooling systems that direct pressurized oil through channels in the rotor assembly. Cooling the rotor allows the efficiency of the motor to be increased. Cooling systems may be particularly desirable in higher performance electric motors with comparatively high efficiency targets. An efficiency of the electric motor may be at least partially based on an efficiency of the cooling provided to the electric motor and its components. For example, cooling the components of the electric motor may allow thermal efficiency and removal of thermal energy to be increased. Cooling may in this way allow the electric motor to generate more rotational power using less electrical power, as removing heat from windings and other electrical components may increase a conductivity of the components. Stator windings may represent one component in which previous examples of cooling may be insufficient. Other components which may demand enhancements in cooling may include the rotor, the motor shaft, and bearings of the motor.

Coolant controlled hollow multipiece rotor shafts for high performance electric motor applications include channels in the rotor shaft that guide coolant closer to internal walls of the rotor shaft. For rotor shafts with variable diameters along a length of the rotor shaft, and particularly in cases where an inlet diameter and an outlet diameter of the rotor shaft are smaller than a central portion of the rotor shaft between the inlet and the outlet, a design of the rotor shaft is desired that avoids churning losses that may result in torque drop. Churning losses may be reduced by directing liquid flow in a way that prevents flooding of a core of the rotor shaft. Guiding liquid flow closer to internal walls of the hollow shaft increases heat transfer efficiency from the rotor shaft to the circulating coolant. Previous attempts to achieve efficient cooling of rotor shafts and prevent flowing of the core of the rotor shaft include positioning a flow insert in the hollow core of the rotor shaft. The flow insert may guide the coolant closer to an inner diameter (e.g., internal walls) of the rotor shaft. The flow insert is configured to retain a structural integrity thereof by resisting liquid pressures at high revolutions per minute (RPM), such as up to 21600 RPM. A flow insert is desired that provides increased cooling efficiency of the rotor shaft, is resistant to structural degradation at high RPM, does not contribute to generating shock loads at high RPMs, and prevents coolant from leaking into an inner core of the flow insert, which may contribute to rotor mass imbalance.

In one example, the issues described above may be addressed by flow insert, comprising an inner core formed of a first material and an outer shell formed of a second material different from the first material. The outer shell is overmolded over the inner core, and the outer shell comprises flow channels.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

The above, as well as other advantages of the present disclosure, will become readily apparent to those skilled in the art from the following detailed description when considered in light of the accompanying drawings in which:

FIG. 1 is a schematic depiction of an example vehicle powertrain, according to an embodiment of the present disclosure;

FIG. 2 is a schematic depiction of a motor of the vehicle powertrain, according to an embodiment of the present disclosure;

FIG. 3 is a depiction of a rotor shaft assembly of the rotor assembly, according to an embodiment of the present disclosure;

FIG. 4 is a cross-section view of the rotor shaft assembly, according to an embodiment of the present disclosure;

FIG. 5 is a perspective view of a first example of a flow insert of the rotor shaft assembly, according to an embodiment of the present disclosure;

FIG. 6 is a side view of the first example of the flow insert of FIG. 5;

FIG. 7 is a first cross-section view of the first example of the flow insert of FIG. 5;

FIG. 8 is a cross-section view of a second example of a flow insert of the rotor shaft assembly, according to an embodiment of the present disclosure;

FIG. 9 is a cross-section view of a third example of a flow insert of the rotor shaft assembly, according to an embodiment of the present disclosure;

FIG. 10 is a cross-section view of a fourth example of a flow insert of the rotor shaft assembly, according to an embodiment of the present disclosure;

FIG. 11 shows a flow chart of a method for forming the flow insert, according to an embodiment of the present disclosure; and

FIG. 12 is a second cross-section view of the first example of the flow insert of FIG. 5, with a solid interior.

### DETAILED DESCRIPTION

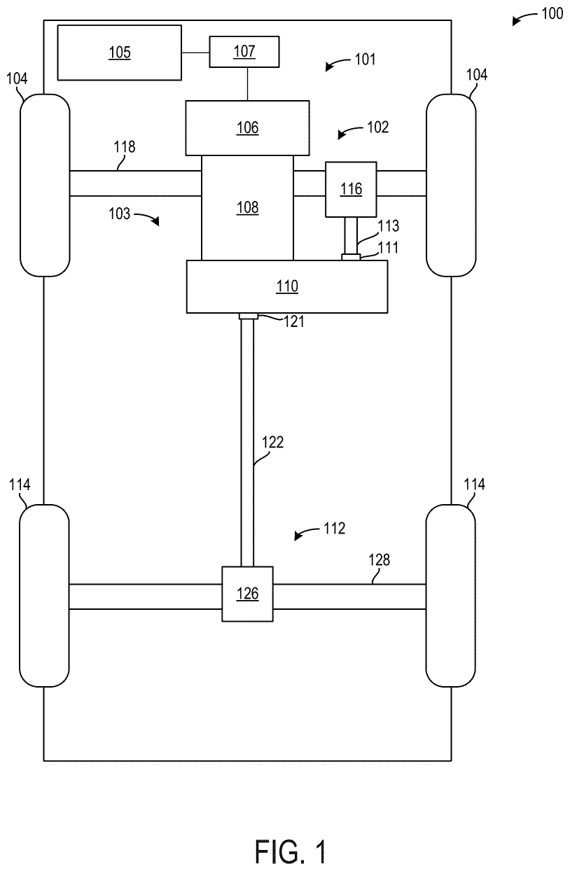

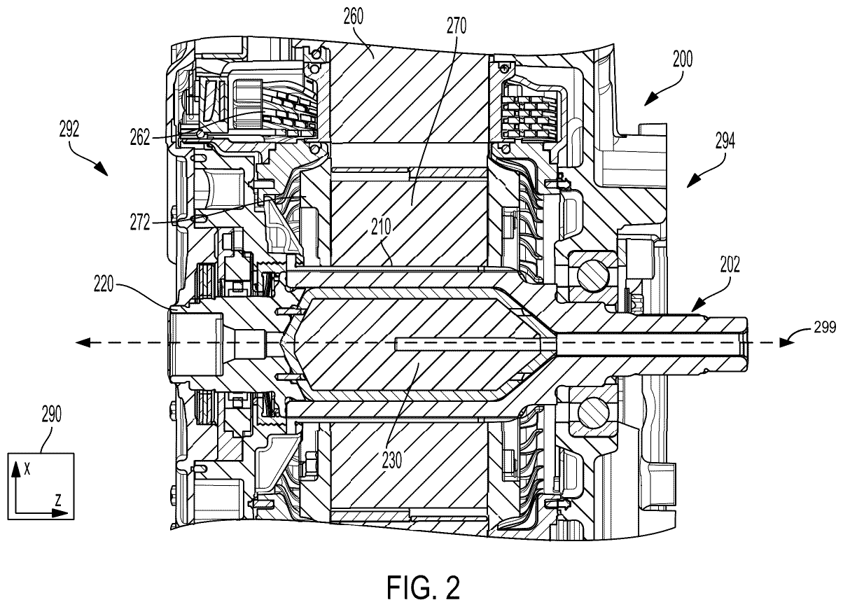

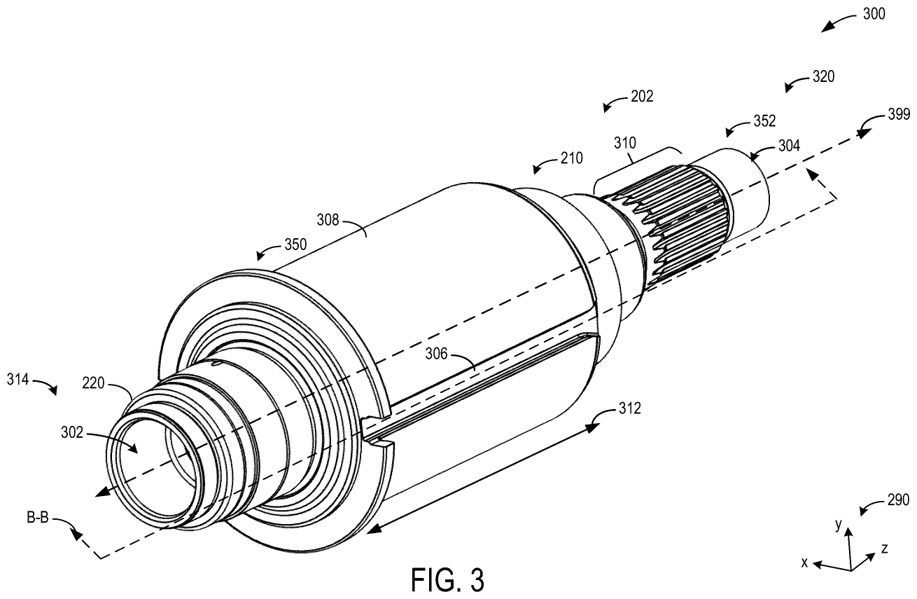

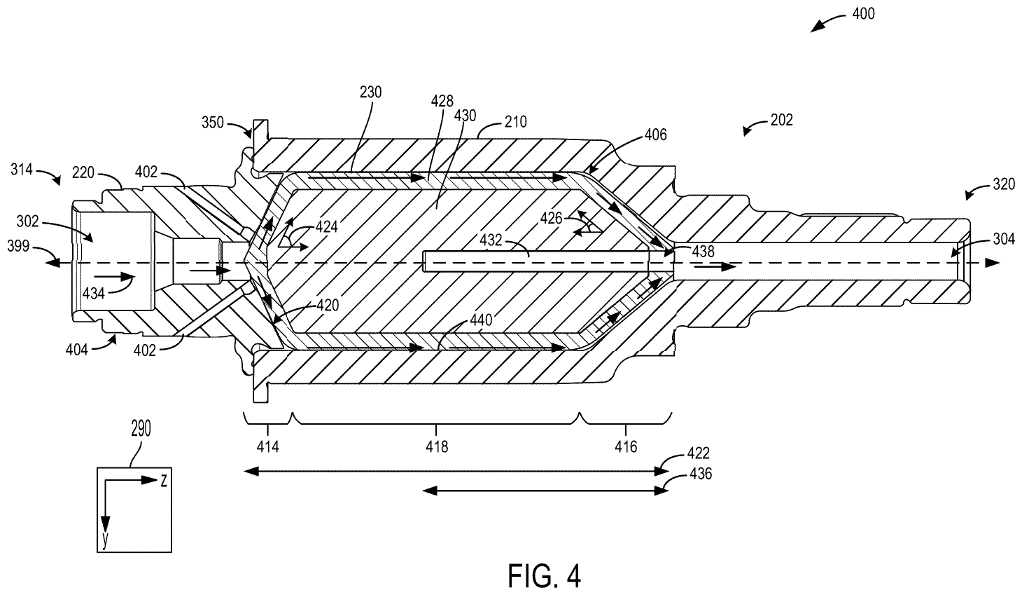

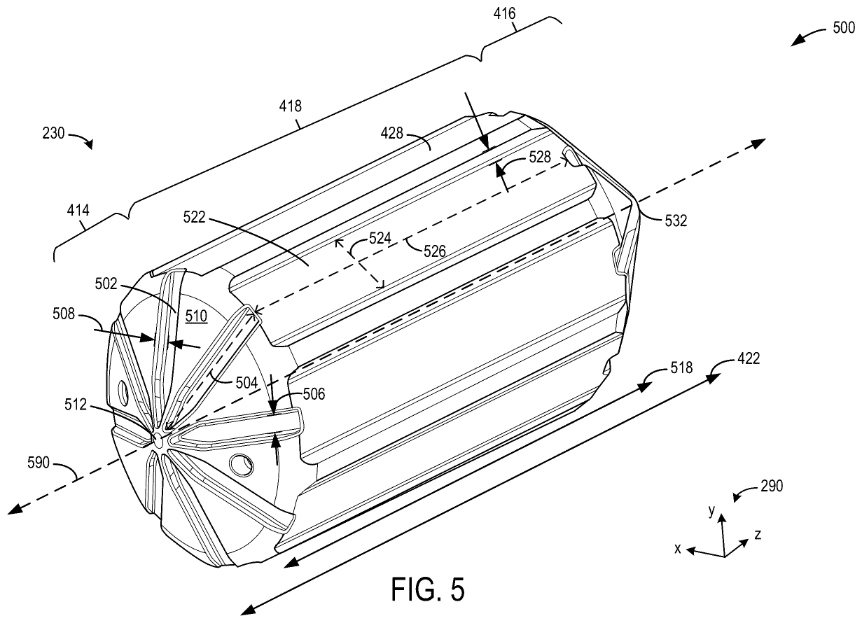

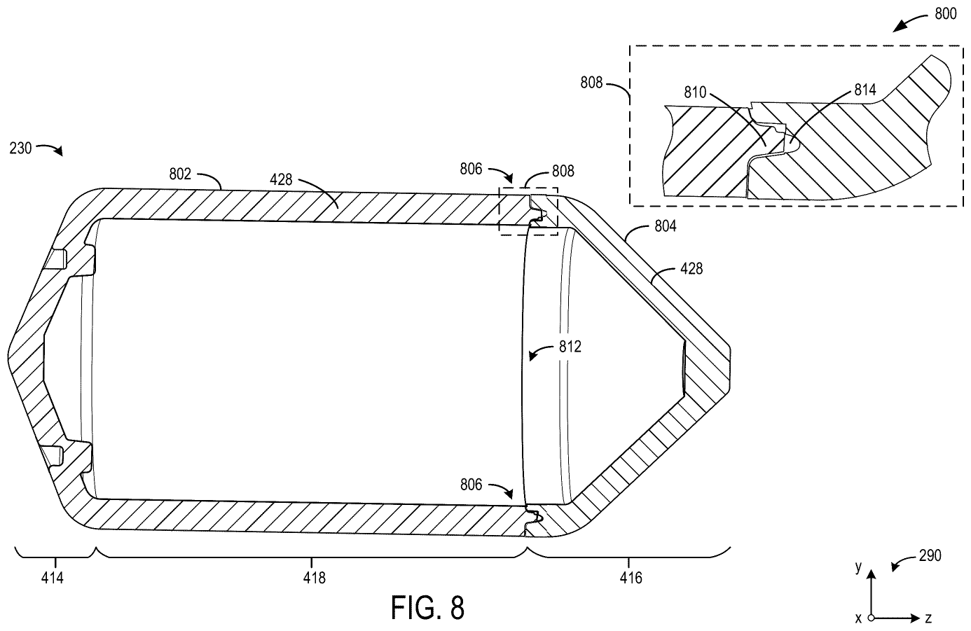

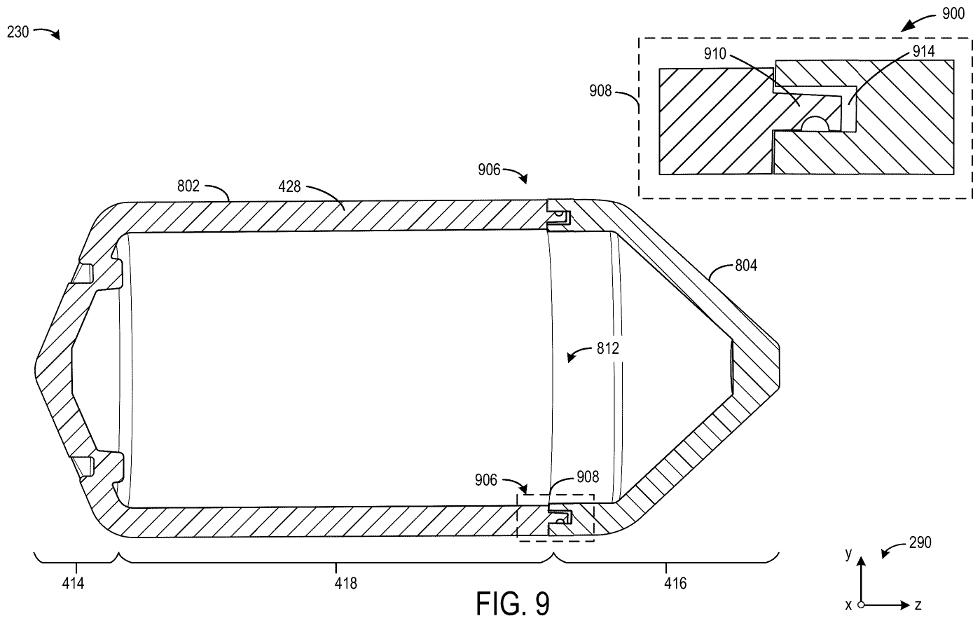

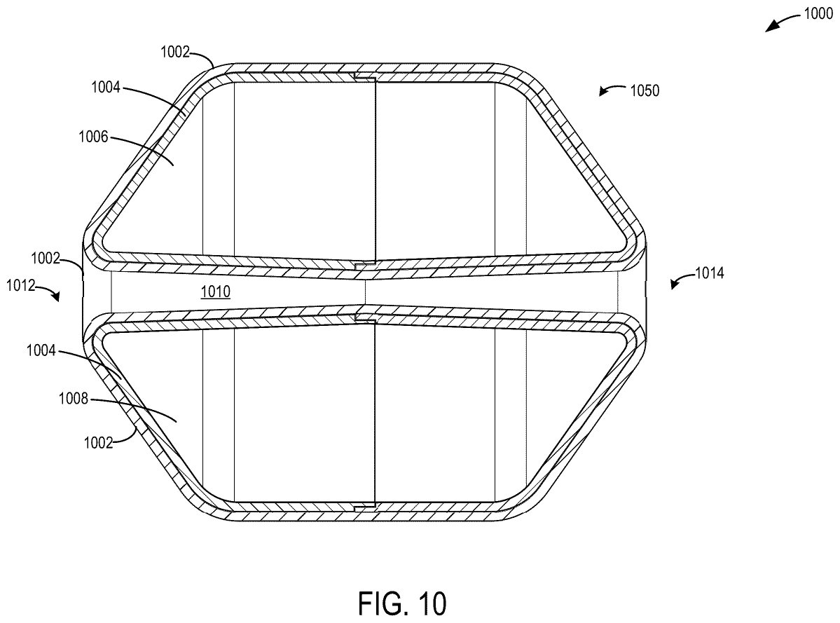

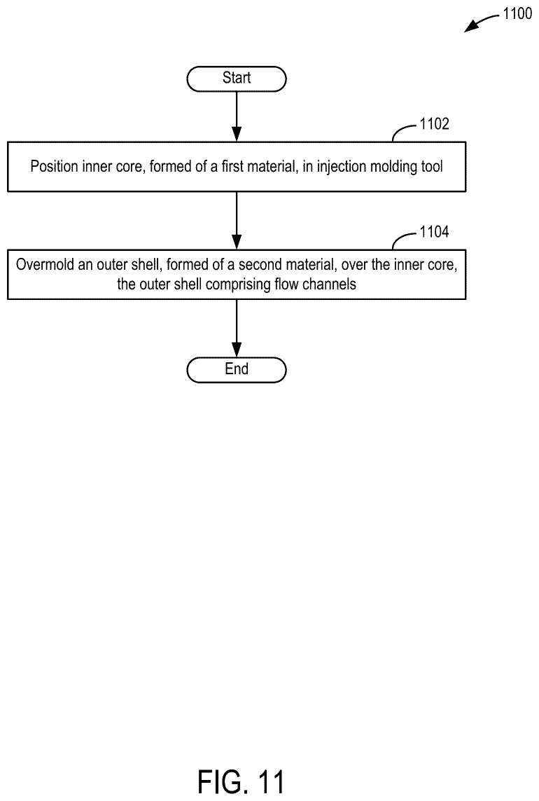

The following description relates to systems for a flow insert of a rotor shaft assembly for a drive unit. In one example, the drive unit is an electric motor of a vehicle, as illustrated in FIG. 1. FIG. 2 is a cross-sectioned view of the electric motor, and illustrates a rotor shaft assembly for a rotor. FIG. 3 shows a perspective view of the rotor shaft assembly of FIG. 2. FIG. 4 is a cross-section view of the rotor shaft assembly, and shows a flow insert positioned in a cavity shaped by a shaft and a shaft end cap of the rotor shaft assembly. The flow insert comprises an inner core formed of a first material and an outer shell formed of a second material different from the first material, where the outer shell is overmolded over the inner core and the outer shell comprises flow channels. A first example of the flow insert is shown in FIGS. 5-7, and 12, and comprises a plastic outer shell overmolded onto an inner core. A second example of the flow insert is shown in FIG. 8, where the outer shell of the flow insert is formed of two pieces that are coupled via ultrasonic welding. A third example of the flow insert is shown in FIG. 9, where the outer shell of the flow insert is formed of two pieces that are coupled by glue. A fourth example of the flow insert is shown in FIG. 10, where the inner core is a two-piece cup with a channel that extends between and liquidly separates a first cup and a second cup of the two-piece cup. One or more of the first, second, third, and fourth examples of the flow insert may be formed using a method described with respect to a flow chart of FIG. 11.

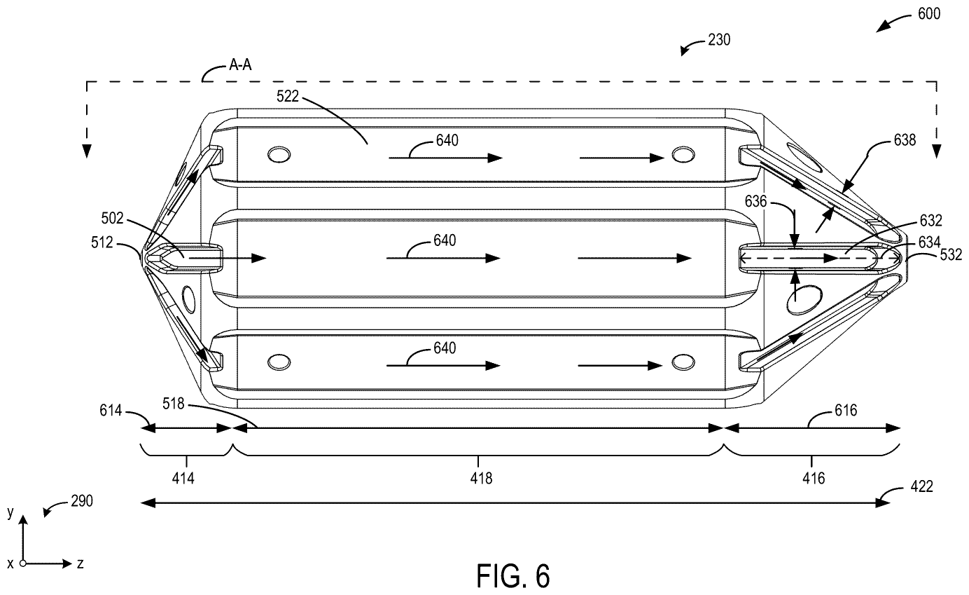

Examples of the overmolded flow insert described herein provide a liquid flow directing component for a rotor shaft assembly that reduces churning losses, is more resistant to structural degradation from coolant exposure, and is more resistant to structural degradation due to vibration and pressure, compared to conventional flow inserts. In overmolded flow insert designs with no discontinuity in the outer shell (e.g., described with respect to FIGS. 5-6) and where the outer shell is a single unit, leakage of coolant into the inner core of the flow insert is blocked. Further, in flow insert designs having an inner core (e.g., described with respect to FIGS. 5-10), coolant may not enter an inner hollow space of the outer shell, as the inner hollow space is filled by the inner core with no gap between the inner core and the outer shell. This prevents churning losses which may occur from coolant leaking into the inner hollow space. In examples where the plastic used to form the outer shell of the flow insert is polyphenylene sulfide (PPS), the outer shell may be dimensionally stable after an injection molding process used to form the outer shell. PPS is compatible with a wide range of chemicals, and may thus be exposed to coolant for long periods of time and/or a long duration with minimal structural degradation of the outer shell. The presence of the plastic outer shell of the flow insert further dampens a vibrational effect of the flow insert within the shaft when the shaft rotates at a high speed (e.g., high RPM). Dampening of the vibrational effect may reduce structural degradation of the flow insert and the shaft. Additionally, forming the outer shell of the flow insert via injection molding plastic offers a flexibility in terms of design complexity. Complex groove shapes may be used to form flow channels of the outer shell. Thus, flow channels may be formed that direct liquid (e.g., coolant flow) in a flow direction that efficiently cools the shaft and other element of the rotor assembly. Injection molding of plastic further provides a precise tolerance control of the overall flow insert. In examples of the flow insert that include a rigid inner core (e.g., formed of aluminum), the flow insert may be further resistant to external coolant centripetal pressure at high RPMs, compared to hollow flow inserts and/or flow inserts having an inner core formed of a different, non-rigid material. An inner core formed of a rigid material further provides resistance to pressure during injection of overmolded plastic to form the outer shell.

FIGS. 2-10 show example configurations with relative positioning of the various components of the present disclosure. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation). FIGS. 2-10 are shown approximately to scale, however, other dimensions may be used if desired.

Turning to FIG. 1, a vehicle 100 is shown comprising a powertrain 101 and a drivetrain 103. The powertrain comprises a prime mover 106 and a transmission 108. The prime mover 106 may be an internal combustion engine or an electric motor, for example, and is operated to provide rotary power to the transmission 108. The transmission 108 may be any type of transmission, such as a manual transmission, an automatic transmission, or a continuously variable transmission. The transmission 108 receives the rotary power produced by the prime mover 106 as an input and outputs rotary power to the drivetrain 103 in accordance with a selected gear or setting.

The prime mover 106 may be powered via energy from an energy storage device 105. In one example, the energy storage device 105 is a battery configured to store electrical energy. An inverter 107 may be arranged between the energy storage device 105 and the prime mover 106 and configured to adjust direct current (DC) to alternating current (AC). The prime mover 106 may include a variety of components and circuitry with thermal demands that effect an efficiency of the prime mover. As will be described herein, the prime mover 106 may include a rotor shaft assembly configured to meet the thermal demands and the structural integrity demands of the components of the prime mover 106. The rotor shaft assembly of the prime mover 106 is described in greater detail with respect to FIGS. 2-4 herein.

The vehicle 100 may be a commercial vehicle, light, medium, or heavy duty vehicle, a passenger vehicle, an off-highway vehicle, and sport utility vehicle. Additionally or alternatively, the vehicle 100 and/or one or more of its components may be in industrial, locomotive, military, agricultural, and aerospace applications. In one example, the vehicle 100 is an electric vehicle.

In some examples, such as shown in FIG. 1, the drivetrain 103 includes a first axle assembly 102 and a second axle assembly 112. The first axle assembly 102 may be configured to drive a first set of wheels 104, and the second axle assembly 112 may be configured to drive a second set of wheels 114. In one example, the first axle assembly 102 is arranged near a front of the vehicle 100 and thereby comprises a front axle, and the second axle assembly 112 is arranged near a rear of the vehicle 100 and thereby comprises a rear axle. The drivetrain 103 is shown in a four-wheel drive configuration, although other configurations are possible. For example, the drivetrain 103 may include a front-wheel drive, a rear-wheel drive, or an all-wheel drive configuration. Further, the drivetrain 103 may include one or more tandem axle assemblies. As such, the drivetrain 103 may have other configurations without departing from the scope of this disclosure, and the configuration shown in FIG. 1 is provided for illustration, not limitation. Further, the vehicle 100 may include additional wheels that are not coupled to the drivetrain 103.

In some four-wheel drive configurations, such as shown in FIG. 1, the drivetrain 103 includes a transfer case 110 configured to receive rotary power output by the transmission 108. A first driveshaft 113 is drivingly coupled to a first output 111 of the transfer case 110, while a second driveshaft 122 is drivingly coupled to a second output 121 of the transfer case 110. The first driveshaft 113 (e.g., a front driveshaft) transmits rotary power from the transfer case 110 to a first differential 116 of the first axle assembly 102 to drive the first set of wheels 104, while the second driveshaft 122 (e.g., a rear driveshaft) transmits the rotary power from the transfer case 110 to a second differential 126 of the second axle assembly 112 to drive the second set of wheels 114. For example, the first differential 116 is drivingly coupled to a first set of axle shafts 118 coupled to the first set of wheels 104, and the second differential 126 is drivingly coupled to a second set of axle shafts 128 coupled to the second set of wheels 114. It may be appreciated that each of the first set of axle shafts 118 and the second set of axle shafts 128 may be positioned in a housing.

In some examples, additionally or alternatively, the vehicle 100 may be a hybrid vehicle including both an engine an electric machine each configured to supply power to one or more of the first axle assembly 102 and the second axle assembly 112. For example, one or both of the first axle assembly 102 and the second axle assembly 112 may be driven via power originating from the engine in a first operating mode where the electric machine is not operated to provide power (e.g., an engine-only mode), via power originating from the electric machine in a second operating mode where the engine is not operated to provide power (e.g., an electric-only mode), and via power originating from both the engine and the electric machine in a third operating mode (e.g., an electric assist mode). As another example, one or both of the first axle assembly 102 and the second axle assembly 112 may be an electric axle assembly configured to be driven by an integrated electric machine.

Turning now to FIG. 2, it shows an embodiment of a motor assembly 200. The motor assembly 200 is an electric machine, such as an electric motor or an electric motor generator. The motor assembly 200 may be an example assembly of the prime mover 106 of FIG. 1, configured as an electric motor. Likewise, the motor assembly 200 may be a configuration of another electric machine of the vehicle 100 of FIG. 1. For example, the motor assembly 200 may be a configuration of an electric machine that may output torque to drive the vehicle 100 with the prime mover 106, such as when the vehicle 100 is a hybrid-electric vehicle. The motor assembly 200 may include a stator 260 and a rotor 270. The stator 260 may include end windings 262 arranged at opposite ends thereof. The rotor 270 may include rotor end caps 272 that interface with a portion of a rotor shaft assembly 202. The rotor 270 may be positioned radially outside of the rotor shaft assembly 202. Elements of the rotor shaft assembly 202 are further described with respect to FIGS. 3-4.

An axis system 290 is shown including an x-axis parallel to an axial direction and a y-axis parallel to a vertical direction. A radial direction is parallel to a plane including the y-axis and a third axis (e.g., a z-axis) normal to the x- and y-axes. The motor assembly 200 may include a first side 292 and a second side 294. The second side 294 may be opposite the first side 292. In one example, the first side 292 is an inlet side and the second side 294 is an output side of the motor assembly 200, wherein power from the motor assembly 200 is transferred to a transmission, gearbox, wheel, or other device at the second side 294.

The rotor shaft assembly 202 may include three main parts, including a shaft 210, a shaft end cap 220, and a flow insert 230. A shaft main body is defined by the shaft 210 and the shaft end cap 220. The shaft 210 and the shaft end cap 220 may be coupled to each other via a weld. The shaft main body may rotate about an axis of rotation 299 that is parallel to the x-axis, based on an operation of the rotor 270. The flow insert 230 may be arranged in a cavity shaped by the shaft 210 and the shaft end cap 220. For example, a body of the shaft 210 forms a cavity, and the cavity may be sealed via the shaft end cap 220. The flow insert 230 may move axially within the cavity. For example, axial play of the flow insert 230 inside the cavity may be between 0.05 mm and 0.5 mm.

Turning to FIG. 3, a perspective view 300 of the rotor shaft assembly 202 of FIG. 2 is shown. The rotor shaft assembly 202 is configured for high RPM use applications. The shaft 210 may be formed of a rigid material that may be welded, such as metal. The shaft end cap 220 may also be formed of a rigid material that may be welded, such as metal. The shaft 210 and the shaft end cap 220 may be formed of the same material or may be formed of different materials, so long as the material of the shaft 210 may be coupled to the material of the shaft end cap 220.

In some examples, a first end 350 of the shaft 210 is coupled to the shaft end cap 220 via a weld joint. A second end 352 of the shaft 210, opposite the first end 350, may also be referred to as a spline side of the shaft 210, as it includes a toothed region 310. The toothed region 310 is configured to mesh with teeth of a gear and/or another shaft to provide rotational output to the meshed gear and/or shaft. For example, the toothed region 310 of the shaft 210 may mesh with and provide rotational power to an input shaft and/or input gear of the transmission 108 of FIG. 1.

A design of the shaft 210 may lock a rotational degree of freedom of the rotor shaft assembly 202 with respect to other elements of the motor assembly 200 (e.g., the rotor 270). For example, a body 308 of the shaft 210 includes a positioning notch 306 that extends along a length 312 of the body 308. The body 308 may include a second positioning notch (not shown) symmetric and parallel to the positioning notch 306, with respect to a central axis 399 of the rotor shaft assembly 202. One or more elements of the motor assembly 200 may include protrusions that are complimentary to the positioning notches of the shaft 210. Engagement of the rotor shaft assembly 202 with rotating elements of the motor assembly 200 via positioning notches of the shaft 210 may enable the rotor shaft assembly 202 to rotate with rotation of the rotating element(s). The rotor shaft assembly 202 is blocked from rotating independently from the rotating element(s), which may reduce degradation of the rotor shaft assembly 202 due to friction with the other elements of the motor assembly 200.

The shaft end cap 220 comprises an inlet 302 at a first end 314 of the rotor shaft assembly 202. The shaft 210 comprises an outlet 304 at a second end 320 of the rotor shaft assembly 202, opposite the first end 314 of the rotor shaft assembly 202. As further shown in FIG. 4, a flow path of the rotor shaft assembly 202 extends from the inlet 302 to the outlet 304. Cooling liquid, such as oil, may flow through the flow path of the rotor shaft assembly 202 to cool the rotor shaft assembly 202 during operation of an electric machine in which the rotor shaft assembly 202 is implemented (e.g., the prime mover 106). Cooling of the rotor shaft assembly 202 may reduce power loss and degradation of the rotor shaft assembly 202 due to undesirably high temperatures.

FIG. 4 shows a cross-sectioned side view 400 of the rotor shaft assembly 202, taken along line B-B of FIG. 3. As described above, the rotor shaft assembly 202 comprises the shaft 210, the shaft end cap 220, and the flow insert 230. The shaft end cap 220 may include at least one angular flow channel 402 that extends from an external surface 404 of the shaft end cap 220, at a non-zero angle, towards the second end 420 of the shaft end cap 220 and the central axis 399. Each of the at least one angular flow channel 402 may be hollow, and thus may reduce a mass of the shaft end cap 220. The flow insert 230 is arranged in a cavity 406 shaped by the shaft 210 and the shaft end cap 220.

In a first example shown in FIGS. 2 and 4, the flow insert 230 may include a cylindrical body 418, a conical front end 414, and a conical rear end 416, opposite the conical front end 414. The cylindrical body 418, the conical front end 414, and the conical rear end 416 are a single, continuous piece with no seams, coupling joints, or other connectors therebetween. The cylindrical body 418 may have a decagon cross-sectional shape, with respect to the y-axis. Each of the conical front end 414 and the conical rear end 416 include a conical shape. Additionally or alternatively, one or more of the conical front end 414 and the conical rear end 416 may be frustoconical in shape. The conical front end 414 is radially symmetric about the central axis 399. The conical rear end 416 is symmetric radially symmetric about the central axis 399. The conical front end 414 and the conical rear end 416 may have different lengths and conical angles. For example, the conical front end 414 may be shorter than the conical rear end 416 along a length 422 of the flow insert 230. Walls of the conical front end 414 are positioned at a first angle 424 with respect to the central axis 399. Walls of the conical rear end 416 are positioned at a second angle 426 with respect to the central axis 399. In the example of FIG. 4, the first angle 424 is larger than the second angle 426. The conical front end 414 faces the shaft end cap 220 when the flow insert 230 is positioned in the cavity 406 of the shaft 210. In some examples, the conical front end 414 includes a plurality of anti-rotation features that may mesh with complementary anti-rotation features of the shaft end cap 220 to prevent rotation of the flow insert 230 about the central axis 399 independent of rotation of the shaft 210 and the shaft end cap 220.

The flow insert 230 is formed of an outer shell 428 and an inner core 430. The outer shell 428 is overmolded over the inner core 430. The inner core 430 is formed of a first material. The outer shell 428 is formed of a second material that is different from the first material. For example, the first material may be aluminum. The first material may be, in other examples, polyether ether ketone (PEEK) and/or foamed aluminum. The second materiel may be plastic, such as polyphenylene sulfide (PPS) with 40% glass fiber. As the outer shell 428 is overmolded over the inner core 430, there is no gap between internal walls of the outer shell and an exterior surface of the inner core 430. The outer shell 428 comprises flow channels (not shown in FIG. 4) that extend into the outer shell 428 and do not expose the inner core 430. The outer shell 428 and the inner core 430 may comprise a recess 432 that extends from a second end 438 (e.g., the conical rear end 416) of the flow insert 230, along the central axis 399, for a first length 436 of the flow insert 230. An opening of the recess (e.g., at the second end 438 of the flow insert) is axially aligned (e.g., along the z-axis) with the outlet 304 of the shaft 210.

The flow channels are configured to direct coolant flow through the cavity 406 formed by the shaft 210 and the shaft end cap 220 of the rotor shaft assembly 202. When the flow insert 230 is inserted into the shaft 210 (e.g., positioned in the cavity 406 formed by the shaft 210 and the shaft end cap 220) and the shaft end cap 220 is coupled to the shaft 210, liquid flow (e.g., lubricant, oil) from the inlet 302 of the shaft end cap 220 to the outlet 304 of the shaft 210 is enabled. A gap (e.g., space of the cavity 406 not filled by the flow insert 230) between the outer shell 428 of the flow insert 230 and internal walls 440 of the shaft 210, formed by the flow channels of the outer shell 428, may enable liquid (e.g., oil, lubricant) flow. Oil flow channels of the flow insert 230 guide oil flow towards internal walls 440 of the shaft 210. A series of arrows 434 show liquid (e.g., coolant) flow paths through the rotor shaft assembly 202. Lubricant may flow into the rotor shaft assembly 202 via the inlet 302 of the shaft end cap 220, into a gap between the flow insert 230 and the shaft end cap 220, between the internal walls 440 of the shaft 210 and the outer shell 428 of the flow insert 230, and out of the rotor shaft assembly 202 via the outlet 304 of the shaft 210. The flow insert 230 further provides high dimensional accuracy, compared to other manufacturing techniques such as high pressure die casting or flow forming. The high dimensional accuracy assists in preventing pressure drop at the inlet 302 of the shaft end cap 220.

FIG. 5 shows a perspective view 500 of the first example of the flow insert 230 of FIGS. 2 and 4. The flow insert 230 has a central axis 590. The outer shell 428 is a single, continuous piece that is overmolded (e.g., using injection molding) onto the inner core 430 (not shown in FIG. 5). The outer shell 428 is formed of a second material that completely surrounds the inner core 430, thus no additional bonding and/or coupling material or element is used to bond the outer shell 428 to the inner core 430.

Flow channels comprise grooves in the outer shell 428 that extend from a surface of the outer shell 428 towards the inner core 430, and do not expose the inner core 430. The flow insert 230 may include flow channels on each of the conical front end 414, the cylindrical body 418, and the conical rear end 416. Flow channels of each section of the flow insert 230 may have the same configuration, and may have different configurations than flow channels of other sections of the flow insert 230.

A first flow channel 502 is an example flow channel of the conical front end 414. In the example of FIG. 5, the conical front end 414 includes eight flow channels. In other examples, the conical front end 414 may include more than or less than eight flow channels. Flow channels of the conical front end 414 may be symmetrically arranged about the central axis 590 (e.g., have radial symmetry with respect to the central point 512) of the flow insert 230. Each flow channel of the conical front end 414 may have the same configuration as the first flow channel 502. Characteristics of the first flow channel 502 may be labeled in FIG. 5 on other flow channels of the conical front end 414 for clarity. It is to be understood that each flow channel of the conical front end 414 has the characteristics described with respect to the first flow channel 502. The first flow channel 502 extends from a central point 512 of the conical front end 414. The flow channels of the conical front end 414 may not be fluidly connected or continuous with each other.

The first flow channel 502 may have a rectangular shape with a pointed end near the central point 512 and a rectangular end at an intersection between the conical front end 414 and the cylindrical body 418. For example, the first flow channel 502 has a first length 504, a first width 506 at the intersection between the conical front end 414 and the cylindrical body 418, and a first depth 508. The first depth 508 is a distance that the first flow channel 502 extends from an outer surface 510 of the outer shell 428 towards the inner core 430. The first depth 508 may be the same along the first length 504 of the first flow channel 502. The first flow channel 502 may be continuous with a flow channel of another section (e.g., the cylindrical body 418, the conical rear end 416) of the flow insert 230.

A second flow channel 522 is an example flow channel of the cylindrical body 418. Characteristics of the second flow channel 522 may be labeled in FIG. 5 on other flow channels of the cylindrical body 418 for clarity. It is to be understood that each flow channel of the cylindrical body 418 has the characteristics described with respect to the second flow channel 522. The second flow channel 522 may have a rectangular shape with a second width 524 and a second length 526. The second flow channel 522 has a second depth 528. In some examples, the second depth 528 of the second flow channel 522 is larger than (e.g., extends further into the outer shell 428 towards the inner core 430) the first depth 508 of the first flow channel 502. In other examples, the second depth 528 is equal to the first depth 508. The second width 524 is greater than the first width 506 of the first flow channel 502.

A number of flow channels of the cylindrical body 418 is equal to the number of flow channels of the conical front end 414. Flow channels of the cylindrical body 418 may be symmetrically arranged about the central axis 590 (e.g., have radial symmetry with respect to the central axis 590) of the flow insert 230. For example, flow channels of the cylindrical body 418 may be evenly dispersed about a circumference of the outer shell 428 of the cylindrical body 418. Each flow channel of the cylindrical body 418 may have the same configuration as the second flow channel 522. The flow channels of the cylindrical body 418 may not be fluidly connected or continuous with each other. Flow channels of the conical front end 414 are fluidly coupled to flow channels of the cylindrical body 418. For example, the rectangular end of the first flow channel 502 fluidly couples the first flow channel 502 to the second flow channel 522.

The conical rear end 416 of the flow insert 230 further includes flow channels that each extend from, and are not fluidly connected at, a second central point 532. The second central point 532 is axially aligned with the central point 512 of the conical front end 414 along the central axis 590. Described another way, the flow channels of the conical rear end 416 may not be continuous with each other. The flow channels of the conical rear end 416 may be continuous with flow channels of another section (e.g., the cylindrical body 418) of the flow insert 230. Further detail of the flow channels of the conical rear end 416 is shown in FIG. 6.

FIG. 6 shows a side view 600 of the first example of the flow insert 230 described with respect to FIG. 5. As shown in part in FIGS. 2, 4, and 5, each of the conical front end 414, the cylindrical body 418, and the conical rear end 416 may have different lengths. A first length 614 of the conical front end 414 may be less than the second length 518 of the cylindrical body 418. The first length 614 may further be less than a third length 616 of the conical rear end 416. The second length 518 of the cylindrical body 418 may be greater than the third length of the conical rear end 416. The lengths of each of the conical front end 414, the cylindrical body 418, and the conical rear end 416 may each be configured to fit the flow insert 230 inside of the cavity formed by the shaft 210 and the shaft end cap 220, as shown in FIGS. 2 and 4.

A third flow channel 632 is an example flow channel of the conical rear end 416. Characteristics of the third flow channel 632 may be labeled in FIG. 6 on other flow channels of the conical rear end 416 for clarity. It is to be understood that each flow channel of the conical rear end 416 has the characteristics described with respect to the third flow channel 632. The conical rear end 416 includes a number of flow channels that is equal to the number of flow channels of the cylindrical body 418. The third flow channel 632 may have a rectangular shape with a pointed end near the second central point 532 and a rectangular end at an intersection between the conical rear end 416 and the cylindrical body 418. The third flow channel 632 has a third length 634, a third width 636 at the intersection between the conical rear end 416 and the cylindrical body 418, and a third depth 638. The third depth 638 may be the same along the third length 634 of the third flow channel 632. In some examples, the third depth 638 of the third flow channel 632 is less than (e.g., does not extend as far into the outer shell 428 towards the inner core 430) the second depth 528 of the second flow channel 522. In other examples, the third depth 638 is equal to the second depth 528. The third width 636 is less than the second width 524 of the second flow channel 522. The rectangular end of a third flow channel 632 may fluidly connect the third flow channel 632 to the second flow channel 522.

Liquid, such as an oil or another lubricant, may flow into the rotor shaft assembly 202 via the inlet 302 of the shaft end cap 220 and is directed through the cavity 406 to the outlet 304 of the shaft 210 by the flow channels of the flow insert 230. A series of arrows 640 in FIG. 6 show liquid flow as guided by the flow channels. From the inlet 302, liquid is deposited into and flows along each flow channel of the conical front end 414. Liquid may be directed from the flow channels of the conical front end 414 into the flow channels of the cylindrical body 418. Each flow channel of conical front end 414 is fluidly connected to a flow channel of the cylindrical body 418, as described with respect to the first flow channel 502 and the second flow channel 522. Liquid may be directed from the flow channels of the cylindrical body 418 to the flow channels of the conical rear end 416. Liquid may be directed from the flow channels of the conical rear end 416 to the outlet 304 of the shaft 210 and out of the rotor shaft assembly 202.

Liquid may flow through each flow channel of each of the conical front end 414, the cylindrical body 418, and the conical rear end 416. In addition to directing liquid from the outlet 304 to the inlet 302, the flow channels of the flow insert 230 may direct liquid away from the central axis 399 of the flow insert 230 and towards internal walls 440 of the shaft 210. This direction of liquid via the flow channels functions to cool the shaft 210 (e.g., both internal walls 440 and external walls of the shaft 210). Cooling of the shaft 210 may assist in reducing degradation of the shaft 210 and other rotating and/or non-rotating parts of the motor assembly.

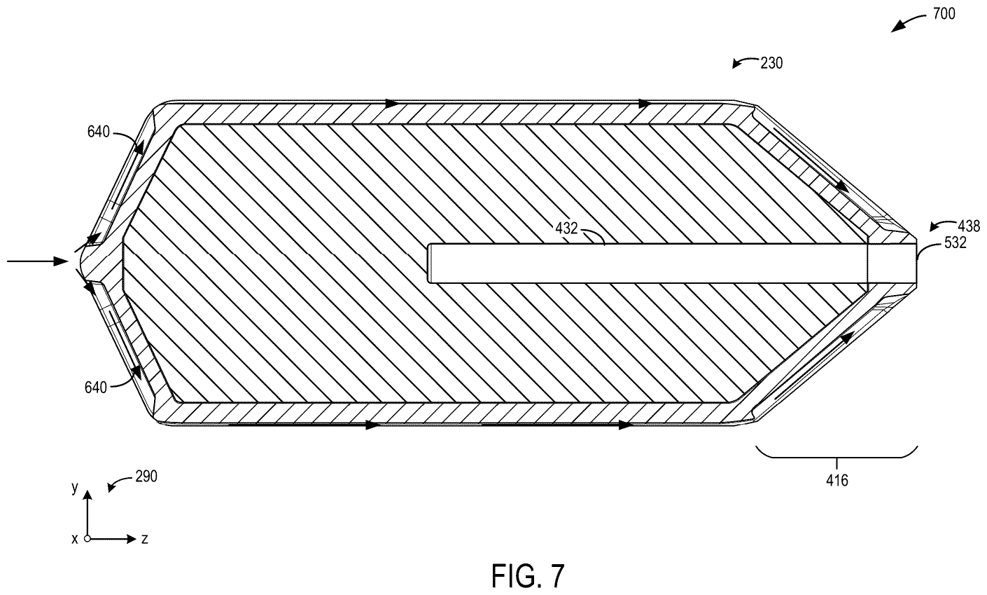

FIG. 7 shows a cross-section view 700 of the first example of the flow insert 230 of FIGS. 4-6. In some examples, the flow insert 230 includes the recess 432 at the second end 438 (e.g., at the conical rear end 416). The recess may be axially aligned with the second central point 532. During flow of liquid as directed by the flow channels of the flow insert 230 (e.g., illustrated by the series of arrows 640). For example, a direction of flow of the liquid may be established by a force directing liquid into the rotor shaft assembly 202 (e.g., a pump of the cooling and/or lubrication system of the vehicle 100), that directs liquid from the inlet 302 to the outlet 304. In some scenarios, liquid may be blocked from exiting the rotor shaft assembly 202 via the outlet 304, and/or may be prevented from flowing in the pumped direction further downstream of the rotor shaft assembly 202.

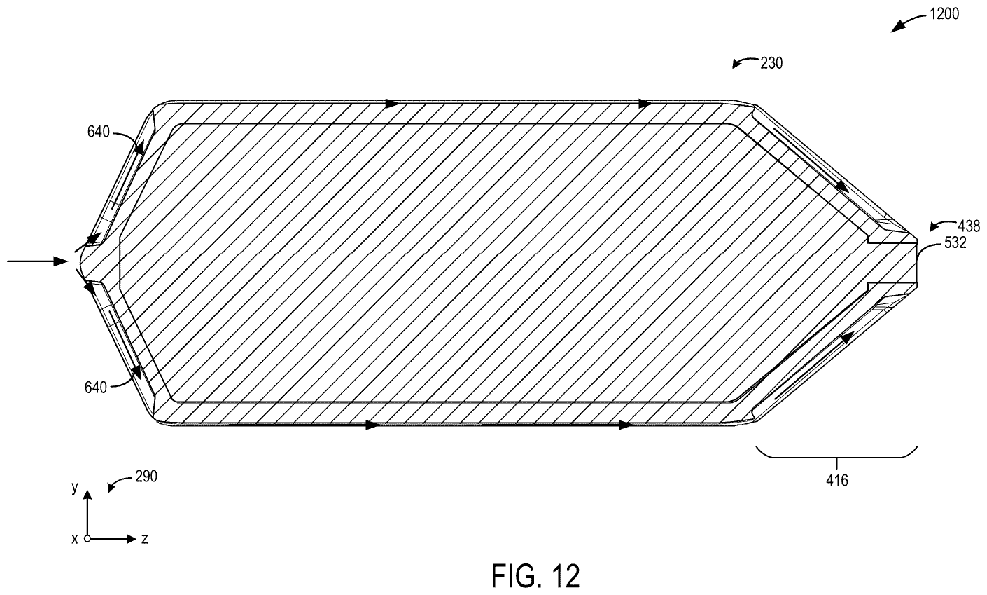

FIG. 12 shows an additional embodiment of the first example of the flow insert 230 of FIGS. 4-7. A cross-section view 1200 of FIG. 12 shows the same liquid flow paths through flow channels of the flow insert 230 as illustrated by the series of arrows 640 in FIGS. 6-7. In the example of FIG. 12, the flow insert 230 has a solid (e.g., non-hollow) interior. The flow insert 230 of FIG. 12 may be manufactured as a single, continuous piece. For example, the flow insert 230 may be formed by injection molding the illustrated geometry using a thermoset plastic material. In another example, the flow insert 230 may be machined from a solid, circular cross-section plastic bar that is formed of thermoset and/or thermoplastic material. In this way, the flow insert may be formed as a single, continuous piece with a solid interior.

Further examples of the flow insert 230 may have different configurations that reduce a mass of the flow insert 230 while providing desired structural integrity and resistance to degradation. FIGS. 8-10 show additional examples of a flow insert comprising an inner core formed of a first material, and an outer shell formed of a second material that is different from the first material, where the outer shell is overmolded over the inner core and where the outer shell comprises flow channels.

FIG. 8 shows a cross-section side view 800 of a second example of the flow insert 230. In the second example, the outer shell 428 of the flow insert 230 is formed of a body piece 802 and a cap piece 804 that are fixedly coupled together. For example, the body piece 802 comprises the conical front end 414 and the cylindrical body 418, and the cap piece 804 comprises the conical rear end 416. The body piece 802 and the cap piece 804 may be welded together via ultrasonic welding. For example, the body piece 802 and the cap piece 804 may be welded together at weld joints 806. Two weld joints 806 are shown in the example of FIG. 8 and in further detail in a dashed line box 808. The flow insert 230 may include more than or less than two weld joints 806 in other examples. The weld joints 806 comprise a protrusion 810 that extends from a second end 812 of the body piece 802. A socket 814 that is complementary to the protrusion 810 of the body piece 802 is formed in the cap piece 804. For example, the socket is configured to receive the protrusion, where the protrusion may or may not be in face sharing contact with one or more walls of the socket. The protrusions 810 may be inserted into, be received by, and be in surface sharing contact with the complementary sockets 814. The weld joint 806 is formed therebetween by welding the protrusion 810 and the socket 814 together.

FIG. 9 shows a cross-section side view 900 of a third example of the flow insert 230. The third example is similar to the second example of FIG. 8, where the outer shell 428 of the flow insert 230 is formed of the body piece 802 and the cap piece 804 that are fixedly coupled together. In the example of FIG. 9, the body piece 802 and the cap piece 804 may be glued together using a bonding glue. Two mating joints 906 are shown in the example of FIG. 9 and in further detail in a dashed line box 908. The flow insert 230 may include more than or less than two mating joints 906 in other examples. The mating joints 906 each comprise a protrusion 910 that extends from a second end 812 of the body piece 802. A socket 914 that is complementary to the protrusion 910 of the body piece 802 is formed in the cap piece 804. The protrusions 910 may be inserted into, be received by, and be in surface sharing contact with the complementary sockets 914. The mating joint 906 is formed therebetween. For example, glue or another bonding adhesive may be injected into the socket 914 and/or coated on the protrusion 910, and the protrusion 910 is inserted into the socket 914 to join the body piece 802 and the cap piece 804.

FIG. 10 shows a cross-sectional side view 1000 of a fourth example of a flow insert 1050. The flow insert 1050 includes similar elements as the flow insert 230 described herein, such as an outer shell 1002 formed over an inner core 1004. The outer shell 1002 is overmolded over the inner core 1004, and the outer shell 1002 comprises flow channels. In the example of FIG. 10, the inner core 1004 comprises a two-piece cup, wherein a first cup 1006 and a second cup 1008 of the two-piece cup are hollow. The outer shell 1002 is overmolded over the two-piece cup to form a channel 1010 that extends between a first end 1012 of the flow insert 1050 to a second end 1014 of the flow insert 1050, and fluidly separates the first cup 1006 and the second cup 1008. Liquid may flow through the channel 1010 from the first end 1012 to the second end 1014.

Turning to FIG. 11, a flow chart illustrates a method 1100 for manufacturing a flow insert, comprising an inner core formed of a first material; and an outer shell formed of a second material different from the first material, where the outer shell is overmolded over the inner core, and where the outer shell comprises flow channels. The method 1100 may thus be used to manufacture one or more of the examples of the flow insert 230 described with respect to FIGS. 2-9, and the flow insert 1050 described with respect to FIG. 10.

At 1102, the method 1100 includes positioning an inner core into an injection molding tool. The inner core may be formed of a first material, such as aluminum, PEEK, and/or foamed aluminum. In some examples, the inner core may be a solid form. In other examples, the inner core may be a shell with a hollow interior.

At 1104, the method 1100 includes overmolding an outer shell over the inner core. The outer shell may be formed of a second material, different from the first material. For example, the outer shell may be formed of plastic, such as PPS that includes 40% glass fiber. This process creates a composite, two-material flow insert. By injection molding the outer shell over the inner core, flow channels are formed in the outer shell that guide a desired volume of liquid (e.g., oil) at a desired flow rate. The outer shell entirely surrounds the inner core; thus no additional steps are performed to bond the first material to the second material. After 1104, the method 1100 ends.

In this way, the flow insert comprising an inner core formed of a first material and an outer shell formed of a second material, different from the first material, and where the outer shell is overmolded over the inner core and comprises flow channels, provides a lightweight solution for a rotor shaft that also enables efficient lubrication and cooling thereof. Technical benefits of the flow insert described herein include reduced energetic losses due to excessive heating of a rotor shaft assembly in which the flow insert is arranged. Additionally, the flow insert provides reduced degradation thereof and of other components of the rotor shaft assembly due to overmolding of the outer shell over the inner core. The overmolding prevents liquid from leaking into the inner core which prevents potential degradation to components of the rotor shaft assembly due to imbalanced rotation caused by liquid in the inner core. Forming the flow insert in part of plastic enables a reduced mass of the rotor shaft assembly, compared to rotor shaft assemblies having metal or other dense materials forming the flow insert.

The disclosure also provides support for a flow insert, comprising: an inner core formed of a first material, and an outer shell formed of a second material different from the first material, where the outer shell is overmolded over the inner core, and where the outer shell comprises flow channels. In a first example of the system, the first material is aluminum. In a second example of the system, optionally including the first example, the first material is polyether ether ketone (PEEK). In a third example of the system, optionally including one or both of the first and second examples, the first material is foamed aluminum. In a fourth example of the system, optionally including one or more or each of the first through third examples, the second material is polyphenylene sulfide with 40% glass fiber. In a fifth example of the system, optionally including one or more or each of the first through fourth examples, there is no gap between internal walls of the outer shell and an exterior surface of the inner core. In a sixth example of the system, optionally including one or more or each of the first through fifth examples, the flow insert comprises a recess that extends from a second end of the flow insert along a central axis of the flow insert for a first length of the flow insert. In a seventh example of the system, optionally including one or more or each of the first through sixth examples, the outer shell is injection molded over the inner core. In an eighth example of the system, optionally including one or more or each of the first through seventh examples, the flow channels comprise grooves in the outer shell that extend from a surface of the outer shell towards the inner core, and do not expose the inner core. In a ninth example of the system, optionally including one or more or each of the first through eighth examples, the outer shell is formed of a body piece and a cap piece that are fixedly coupled together. In a tenth example of the system, optionally including one or more or each of the first through ninth examples, the body piece and the cap piece are welded together via ultrasonic welding. In a eleventh example of the system, optionally including one or more or each of the first through tenth examples, the system further comprises: a protrusion that extends from the body piece, and a socket of the cap piece that is complementary to the protrusion, where at least one of the protrusion and the socket is coated in a bonding adhesive that bonds the protrusion and the socket when the protrusion is inserted into the socket. In a twelfth example of the system, optionally including one or more or each of the first through eleventh examples, the inner core comprises a two-piece cup, wherein a first cup and a second cup of the two-piece cup are hollow and the outer shell is overmolded over the two-piece cup to form a channel that extends between a first end of the flow insert to a second end of the flow insert and fluidly separates the first cup and the second cup.

The disclosure also provides support for a rotor shaft assembly, comprising: a shaft, a shaft end cap coupled to the shaft, and a flow insert positioned in a cavity shaped by the shaft and the shaft end cap, where the flow insert is a composite, two-material insert comprising an inner core formed of a first material and an outer shell formed from a second material that is different from the first material, where the outer shell is overmolded over the inner core, and where the outer shell comprises flow channels. In a first example of the system, the system further comprises: a recess that extends from a second end of the flow insert along a central axis of the rotor shaft assembly for a first length of the flow insert, an outlet of the shaft at a second end of the rotor shaft assembly, where an opening of the recess and the outlet of the shaft are axially aligned. In a second example of the system, optionally including the first example, the flow insert comprises: a conical front end having flow channels, a cylindrical body having flow channels that are fluidly coupled to the flow channels of the conical front end, and a conical rear end having flow channels that are fluidly coupled to the flow channels of the cylindrical body. In a third example of the system, optionally including one or both of the first and second examples, the conical front end, the cylindrical body, and the conical rear end are a single, continuous piece with no seams and/or coupling joint. In a fourth example of the system, optionally including one or more or each of the first through third examples, the shaft end cap further comprises at least one angular flow channel that extends from an external surface of the shaft end cap, at a non-zero angle, towards a second end of the shaft end cap and a central axis of the shaft end cap.

The disclosure also provides support for a motor assembly, comprising: a stator, a rotor surrounded by the stator, a shaft at least partially surrounded by the rotor, wherein the shaft comprises a flow insert arranged therein, the flow insert comprising an inner core formed of a first material and an outer shell formed of a second material different from the first material, where the outer shell is overmolded over the inner core, and where the outer shell comprises flow channels, and a shaft end cap coupled to the shaft to form a cavity in which the flow insert is arranged. In a first example of the system, the flow channels of the flow insert are configured to guide oil flow from an inlet of the shaft end cap to an internal wall of the shaft and to an outlet of the shaft.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A flow insert, comprising:
an inner core formed of a first material; and
an outer shell formed of a second material different from the first material, where the outer shell is overmolded over the inner core, and where the outer shell comprises flow channels.

2. The flow insert of claim 1, wherein the first material is aluminum.

3. The flow insert of claim 1, wherein the first material is polyether ether ketone (PEEK).

4. The flow insert of claim 1, wherein the first material is foamed aluminum.

5. The flow insert of claim 1, wherein the second material is polyphenylene sulfide with 40% glass fiber.

6. The flow insert of claim 1, wherein there is no gap between internal walls of the outer shell and an exterior surface of the inner core.

7. The flow insert of claim 1, wherein the flow insert comprises a recess that extends from a second end of the flow insert along a central axis of the flow insert for a first length of the flow insert.

8. The flow insert of claim 1, wherein the outer shell is injection molded over the inner core.

9. The flow insert of claim 1, wherein the flow channels comprise grooves in the outer shell that extend from a surface of the outer shell towards the inner core, and do not expose the inner core.

10. The flow insert of claim 1, wherein the outer shell is formed of a body piece and a cap piece that are fixedly coupled together.

11. The flow insert of claim 10, wherein the body piece and the cap piece are welded together via ultrasonic welding.

12. The flow insert of claim 10, further comprising:
a protrusion that extends from the body piece; and
a socket of the cap piece that is complementary to the protrusion, where at least one of the protrusion and the socket is coated in a bonding adhesive that bonds the protrusion and the socket when the protrusion is inserted into the socket.

13. The flow insert of claim 1, wherein the inner core comprises a two-piece cup, wherein a first cup and a second cup of the two-piece cup are hollow and the outer shell is overmolded over the two-piece cup to form a channel that extends between a first end of the flow insert to a second end of the flow insert and fluidly separates the first cup and the second cup.

14. A rotor shaft assembly, comprising:
a shaft;
a shaft end cap coupled to the shaft; and
a flow insert positioned in a cavity shaped by the shaft and the shaft end cap, where the flow insert is a composite, two-material insert comprising an inner core formed of a first material and an outer shell formed from a second material that is different from the first material, where the outer shell is overmolded over the inner core, and where the outer shell comprises flow channels.

15. The rotor shaft assembly of claim 14, further comprising:
a recess that extends from a second end of the flow insert along a central axis of the rotor shaft assembly for a first length of the flow insert;
an outlet of the shaft at a second end of the rotor shaft assembly, where an opening of the recess and the outlet of the shaft are axially aligned.

16. The rotor shaft assembly of claim 14, wherein the flow insert comprises:
a conical front end having flow channels;
a cylindrical body having flow channels that are fluidly coupled to the flow channels of the conical front end; and
a conical rear end having flow channels that are fluidly coupled to the flow channels of the cylindrical body.

17. The rotor shaft assembly of claim 16, wherein the conical front end, the cylindrical body, and the conical rear end are a single, continuous piece with no seams and/or coupling joint.

18. The rotor shaft assembly of claim 14, wherein the shaft end cap further comprises at least one angular flow channel that extends from an external surface of the shaft end cap, at a non-zero angle, towards a second end of the shaft end cap and a central axis of the shaft end cap.

19. A motor assembly, comprising:
a stator;
a rotor surrounded by the stator;
a shaft at least partially surrounded by the rotor, wherein the shaft comprises a flow insert arranged therein, the flow insert comprising an inner core formed of a first material and an outer shell formed of a second material different from the first material, where the outer shell is overmolded over the inner core, and where the outer shell comprises flow channels; and
a shaft end cap coupled to the shaft to form a cavity in which the flow insert is arranged.

20. The motor assembly of claim 19, wherein the flow channels of the flow insert are configured to guide oil flow from an inlet of the shaft end cap to an internal wall of the shaft and to an outlet of the shaft.
